(19) United States
(12) Patent Application Publication
(10) Pub. No.: US 2003/0127982 A1
(43) Pub. Date: Jul. 10, 2003

(54) Method and apparatus for applying material between barrier ribs on substrate

(75) Inventor: Manabu Yabe, Kyoto (JP)

Correspondence Address: McDermott, Will & Emery, 600 13th Street, N.W., Washington, DC, 20005-3096, US

(73) Assignee: DAINIPPON SCREEN MFG.CO., LTD.

(21) Appl. No.: 10/327,959

(22) Filed: Dec. 26, 2002

(30) Foreign Application Priority Data
Jan. 9, 2002 (JP) P2002-002143
Aug. 12, 2002 (JP) P2002-234783

(51) Int. Cl. H01J 17/49

(52) U.S. Cl. 313/582

(57) ABSTRACT

On a substrate (9) on which barrier ribs (91) are formed, a nozzle (71) is inserted between the barrier ribs (91) and discharges a phosphor paste (92). The nozzle (71) has a slit (712) in a direction orthogonal to a traveling direction and the phosphor paste (92) is discharged from the slit (712) towards a bottom surface and side surfaces of a valley between the barrier ribs (91). The phosphor paste (92) after the discharge is shaped by a rear portion (713) of a tip of the nozzle (71) and applied to the bottom surface and side surfaces of the valley to have an appropriate thickness.

### BACKGROUND OF THE INVENTION

1. Field of the Invention

The present invention relates to a technique to apply a predetermined material between barrier ribs formed on a substrate (or while forming the barrier ribs on a substrate).

2. Description of the Background Art

In manufacturing a panel used for a plasma display, conventionally, barrier ribs are formed on a substrate and a phosphor paste is applied between the barrier ribs. Though application of the phosphor paste is usually carried out by screen printing, a method of discharging the phosphor paste from a nozzle is also proposed. Forming the barrier ribs and application of the phosphor paste are performed in different processes.

In the panel used for the plasma display, to achieve a proper display color, it is necessary to deposit the phosphor paste not only on a bottom surface of a valley which is formed by the barrier ribs but also on side surfaces thereof. Further, the amount of applied paste should be the minimum. It is difficult to achieve such an application by screen printing or simple discharge from the nozzle, and complicate methods have been adopted by trial and error. In fact, however, the paste is so applied as to fill the whole valley or applied on the bottom surface of the valley to have a thickness thicker than necessary.

In conventional methods, since formation of the barrier ribs and application of the material between the barrier ribs are performed in different processes, it is necessary to transfer the substrate between the processes, change a head part of the apparatus and the like, and this arises a problem of increasing the manufacturing cost. This problem is common not only to manufacture of the panel in the plasma display but also to manufacture of a panel and a color filter for a flat panel display, such as an organic EL (electroluminescence) display, which is expected to develop.

### SUMMARY OF THE INVENTION

It is a first object of the present invention to properly perform application of a material to an area between barrier ribs, and it is a second object of the present invention to reduce the cost for processing a substrate for a flat panel display such as a panel and a color filter.

The present invention is intended for a method of applying a predetermined material between barrier ribs formed on a substrate for a flat panel display.

According to an aspect of the present invention, the method comprises a discharge start step of transferring a material discharge part relatively to the substrate in a direction along the barrier ribs and starting discharge of the predetermined material from the material discharge part towards an area between the barrier ribs, a discharge stop step of stopping the discharge of the predetermined material from the material discharge part, and a hardening step of sequentially hardening the predetermined material discharged on the substrate from the discharge start step to the discharge stop step.

By the method of the present invention, it is possible to properly keep the shape of the predetermined material applied between the barrier ribs.

According to another aspect of the present invention, the method comprises a discharge start step of transferring a nozzle inserted between the barrier ribs relatively to the substrate in a direction along the barrier ribs and starting discharge of the predetermined material from the nozzle, and a discharge stop step of stopping the discharge of the predetermined material from the nozzle, and in the method, the nozzle discharges the predetermined material from a portion thereof other than the rear with respect to a traveling direction on the substrate.

According to still another aspect of the present invention, the method comprises a discharge start step of transferring a material discharge part relatively to the substrate in a direction along the barrier ribs and starting discharge of the predetermined material from the material discharge part towards an area between the barrier ribs, a discharge stop step of stopping the discharge of the predetermined material from the material discharge part, and a shaping step of sequentially shaping the predetermined material discharged on the substrate from the discharge start step to the discharge stop step.

By the method of these aspects of the present invention, it is possible to shape the predetermined material while applying the material between the barrier ribs.

The present invention is also intended for a method of forming a pattern on a substrate for a flat panel display.

According to an aspect of the present invention, the method comprises a barrier-rib forming step of forming barrier ribs on a main surface of the substrate, and a material discharge step of discharging a predetermined material towards an area between the barrier ribs on the substrate in parallel with the barrier-rib forming step.

By the method of the present invention, it is possible to reduce the time and cost required to form the barrier ribs and apply the predetermined material between the barrier ribs.

The present invention is further intended for an apparatus for applying a predetermined material between barrier ribs on a substrate, an apparatus for forming a pattern on a substrate and a panel for a flat panel display.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing an overall constitution of a material applying apparatus in accordance with a first preferred embodiment;

FIG. 2 is a bottom view of a material discharge part;

FIG. 3 is a perspective view showing a tip of a nozzle;

FIGS. 4 and 5 are views showing application of a phosphor paste;

FIG. 6 is a flowchart showing an operation of the material applying apparatus;

FIG. 7 is a cross section of a panel;

FIG. 8 is a view showing the vicinity of a head part in a material applying apparatus in accordance with a second preferred embodiment;

FIGS. 9 and 10 are views showing a shaping member and its periphery;

FIG. 11 is a view showing a head part of a pattern forming apparatus and its peripheral constitution in accordance with a third preferred embodiment;

FIGS. 12 and 13 are views showing discharge from the head part;

FIG. 14 is a flowchart showing an operation of the pattern forming apparatus;

FIG. 15 is a view showing a head part of a pattern forming apparatus for a color filter and its peripheral constitution;

FIG. 16 is a perspective view showing another example of the pattern forming apparatus for a color filter;

FIG. 17 is a flowchart showing an operation of the pattern forming apparatus; and

FIG. 18 is a view showing another example of the nozzle.

### DESCRIPTION OF THE PREFERRED EMBODIMENTS

<1. The First Preferred Embodiment>

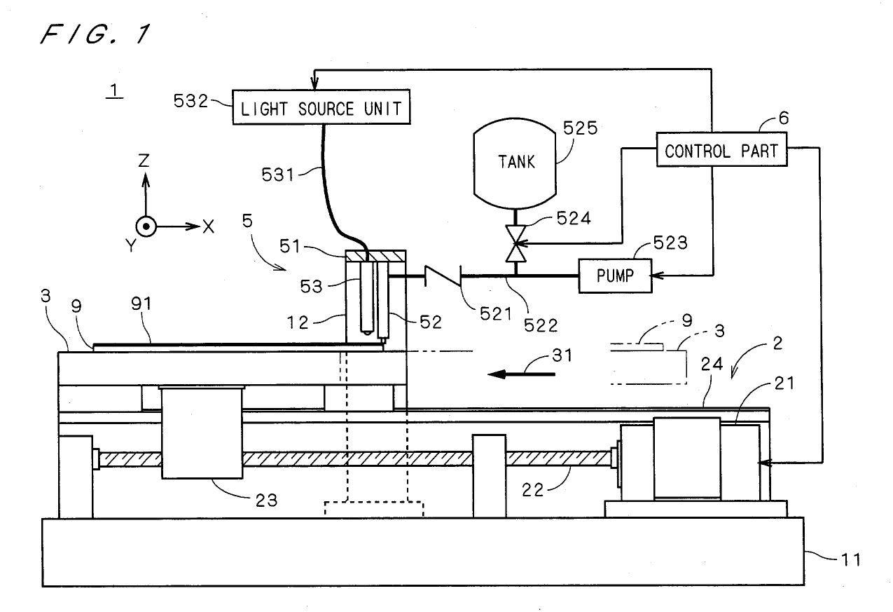

FIG. 1 is a view showing an overall constitution of a material applying apparatus 1 in accordance with the first preferred embodiment of the present invention. The material applying apparatus 1 is an apparatus for applying a phosphor paste between a plurality of barrier ribs 91 formed on a glass substrate (hereinafter, referred to as “substrate”) 9 of a plasma display, and the substrate 9 on which the phosphor paste is applied becomes a panel (usually, rear panel) which is a subassembly of the plasma display through another process.

In the material applying apparatus 1, a stage transfer mechanism 2 is provided on a base 11, and this stage transfer mechanism 2 allows a stage 3 supporting the substrate 9 to travel in the X direction of FIG. 1. A frame 12 is fixed on the base 11 across the stage 3, and a head part 5 is attached to the frame 12.

The stage transfer mechanism 2 has a structure in which a ball screw 22 is connected to a motor 21 and fitted into a nut 23 which is fixed to the stage 3. A guide rail 24 is fixed above the ball screw 22 and when the motor 21 runs, the stage 3 smoothly travels together with the nut 23 along the guide rail 24 in the X direction.

The head part 5 has a material discharge part 52 provided on a lower surface of a base 51, for discharging the phosphor paste which is a rib-space material (i.e., a material discharged between barrier ribs) onto the substrate 9, and an irradiation part 53 for irradiating the substrate 9 with ultraviolet rays, and a supply pipe 522 having a check valve 521 is attached to the material discharge part 52. The supply pipe 522 is branched off into two pipes, one of which is connected to a pump 523 and the other is connected to a tank 525 for pooling the phosphor paste via a control valve 524. The irradiation part 53 is connected to a light source unit 532 for generating the ultraviolet rays through an optical fiber 531.

The motor 21, the pump 523, the control valve 524 and the light source unit 532 are connected to a control part 6, and the material applying apparatus 1, using the control part 6 to control these constituents, applies the phosphor paste onto the substrate 9.

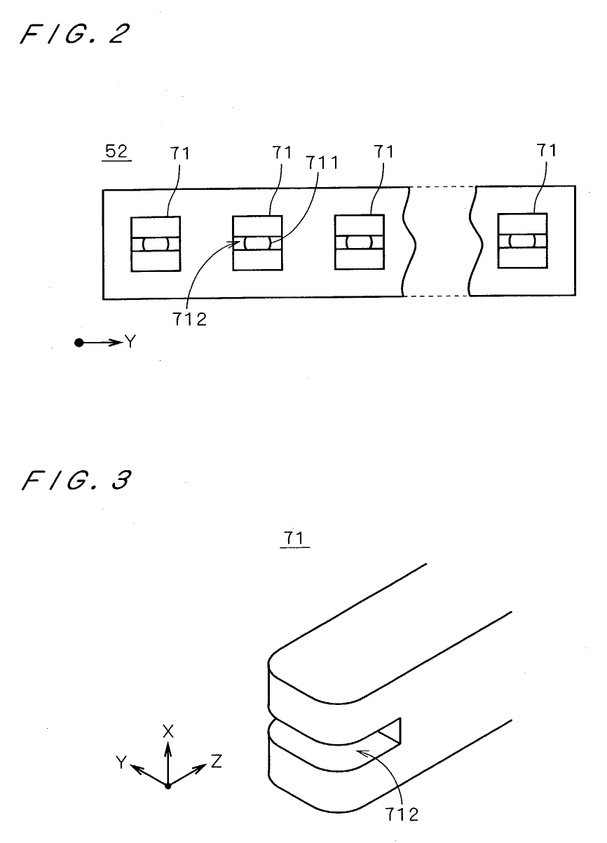

FIG. 2 is a bottom view of the material discharge part 52. In a bottom surface of the material discharge part 52, a plurality of nozzles 71 for discharging the phosphor paste towards the substrate 9 are arranged in a row. FIG. 3 is a perspective view showing a tip of the nozzle 71. The tip of the nozzle 71 has a rounded rectangular shape as viewed from the X direction, being provided with a slit 712 extending in the Y direction. As shown in FIG. 2, each nozzle has a discharge port 711 in its slit 712, for discharging the phosphor paste. In accordance with the shape of the nozzle 71 as viewed from the X direction, the shape of the applied phosphor paste is shaped, as discussed later. The pitch between the nozzles 71 provided in the Y direction is equal to the pitch between the barrier ribs on the substrate 9.

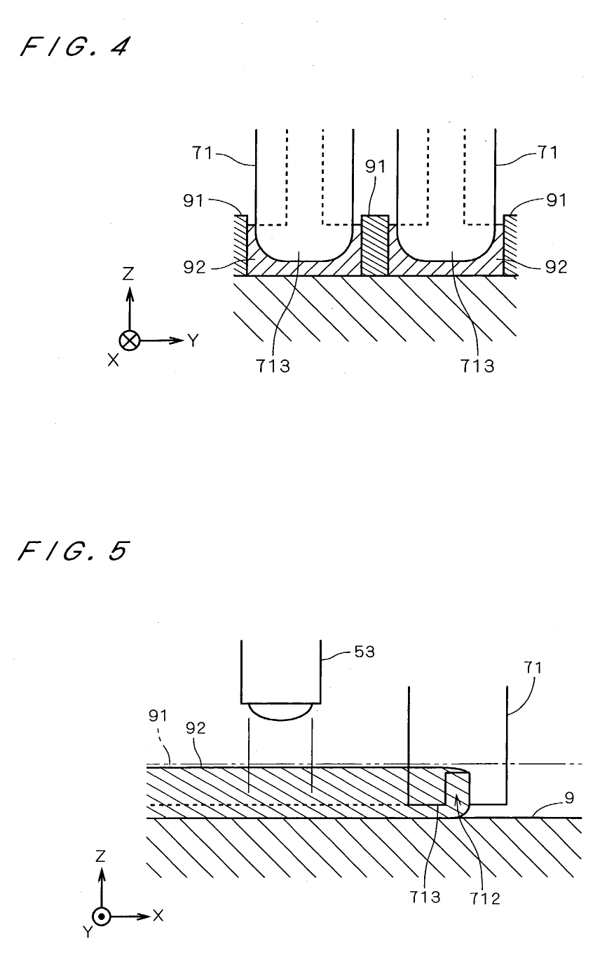

FIG. 4 is a view showing application of the phosphor paste on the substrate 9 as viewed from the (−X) side towards the (+X) side, and FIG. 5 is a view showing the application as viewed from the (+Y) side towards the (−Y) side. Discussion will be made below on a basic operation for application by the material applying apparatus 1, referring to FIGS. 1 to 5.

Discharge of the phosphor paste from the material discharge part 52 is performed by the check valve 521, the pump 523 and the control valve 524 of FIG. 1. First, with control of the control part 6, the pump 523 performs suction while the control valve 524 is open. At this time, since the check valve 521 blocks backflow of the phosphor paste, the phosphor paste is sucked from the tank 525 into the pump 523. Subsequently, with control of the control part 6, the control valve 524 gets closed and the pump 523 performs ejection. With this operation, the material discharge part 52 continuously discharges the phosphor paste.

During discharge of the phosphor paste, the control part 6 drives the motor 21 of the stage transfer mechanism 2 to continuously transfer the stage 3 from a position indicated by the phantom line of FIG. 1 to a position indicated by the solid line in a direction indicated by the arrow 31. The material discharge part 52 thereby travels relatively to the substrate 9 along the barrier ribs 91 extending in the X direction. As a result, the phosphor paste 92 discharged from a group of nozzles 71 towards areas between the barrier ribs 91 are sequentially adhered onto the substrate 9 as shown in FIG. 5.

On the other hand, since the nozzle 71 opens like a slit up to the sides with respect to the traveling direction (relative to the substrate 9) and is inserted between the barrier ribs 91 as shown in FIG. 3, the phosphor paste 92 is surely applied also to the barrier ribs 91 as shown in FIGS. 4 and 5. Further, the phosphor paste 92 is shaped by a rear portion 713 of the nozzle 71, which is behind the slit 712 (with respect to the traveling direction relative to the substrate 9), and applied on the bottom surface and side surface of the valley between the barrier ribs 91 to have a proper thickness.

As shown in FIG. 5, the irradiation part 53 is disposed on the rear of the material discharge part 52 in its traveling direction (relative to the substrate 9) and emits ultraviolet rays while traveling together with the material discharge part 52 relatively to the substrate 9, to thereby sequentially irradiate the phosphor paste 92 on the substrate 9 with the ultraviolet rays immediately after the discharge. The phosphor paste 92 has a fluorescent substance which is an inorganic substance and a vehicle (mixture of organic solvent and resin), and the resin slightly contains a substance which is to be hardened by ultraviolet rays. Therefore, the phosphor paste 92 is sequentially hardened through passage of the irradiation part 53 and the shape of the phosphor paste 92 can be made stable. As a result, it is possible to prevent the phosphor paste 92 on the substrate 9 to be accumulated thickly on the bottom of the valley (i.e., the area between barrier ribs) due to deformation.

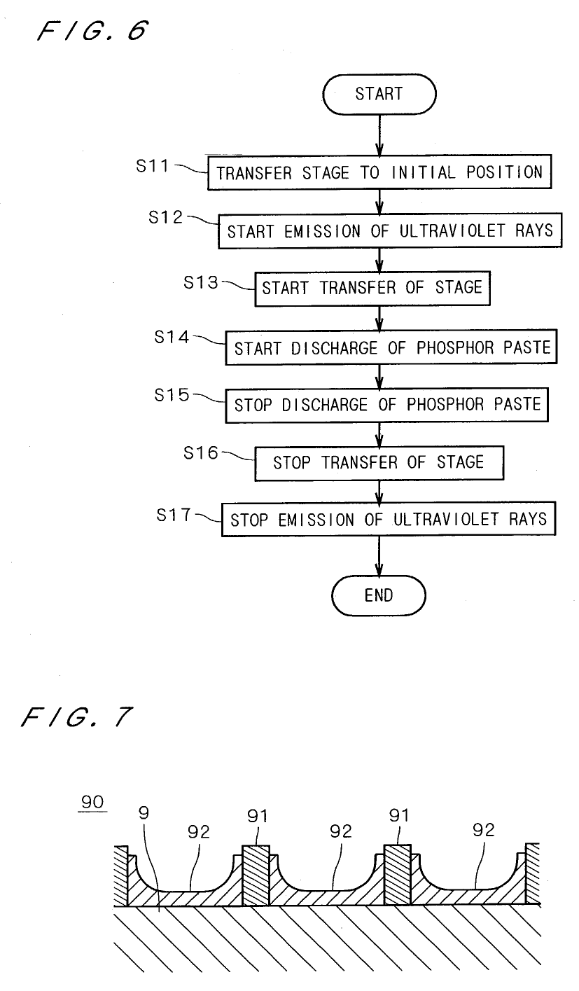

FIG. 6 is a flowchart showing an operation of the material applying apparatus 1. First, the stage 3 is transferred to an initial position indicated by the phantom line of FIG. 1 (Step S11). Next, the irradiation part 53 starts emission of ultraviolet rays (Step S12), and the stage transfer mechanism 2 starts transfer of the stage 3 in the (−X) direction (Step S13).

When the head part 5 reaches a discharge start position near an end of the substrate 9 (near a left end of the substrate 9 in FIG. 1), the material discharge part 52 starts discharge of the phosphor paste 92 (Step S14). Then, when the head part 5 reaches a discharge stop position near the other end (near a right end of the substrate 9 in FIG. 1), the material discharge part 52 stops the discharge of the phosphor paste 92 (Step S15), and the transfer of the stage 3 and the emission of the ultraviolet rays are also stopped (Steps S16 and S17).

Through the above operation, during a period from the start of discharge of the phosphor paste 92 to the stop of discharge, the phosphor paste 92 is sequentially shaped and hardened.

FIG. 7 is a cross section of a panel 90 on which the phosphor paste 92 is applied between the barrier ribs 91. Since a surface of the phosphor paste 92 is shaped in accordance with the shape of the tip of the nozzle 71, the phosphor paste 92 is applied on the bottom surface and side surfaces of the valley between the barrier ribs 91 to have a proper thickness. Further, since the phosphor paste 92 is hardened immediately after being applied, the shape after application can be kept.

<2. The Second Preferred Embodiment>

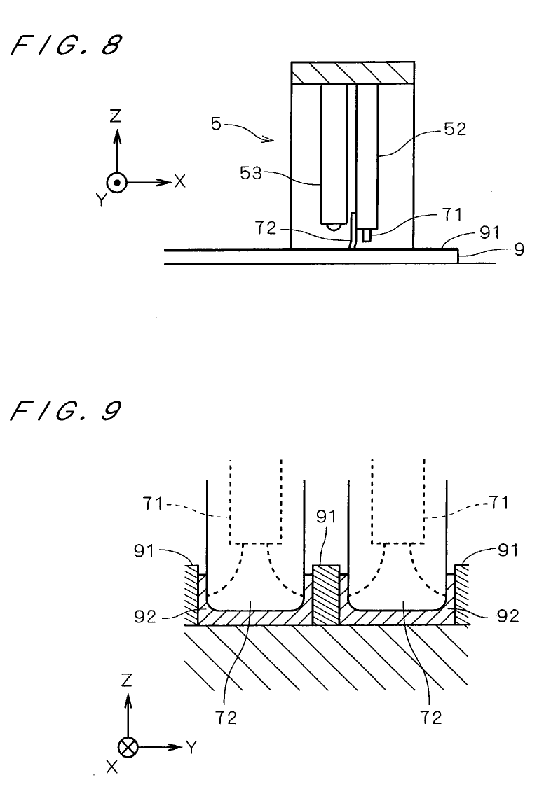

FIG. 8 is a view showing the vicinity of the head part 5 in a material applying apparatus in accordance with the second preferred embodiment. Other constituents of the material applying apparatus are the same as those in the first preferred embodiment and represented by the same reference signs in the following discussion. The operation of the material applying apparatus is the same as shown in FIG. 6.

Though the head part 5 of FIG. 8 is provided with a plurality of nozzles 71 arranged at the tip of the material discharge part 52 in the Y direction, like in the first preferred embodiment, these nozzles 71 are not inserted between the barrier ribs on the substrate 9. Shaping members 72 which are to be inserted between the barrier ribs 91 are additionally provided on the rear side of the tip of the material discharge part 52 (the rear side in the traveling direction of the material discharge part 52 relative to the substrate 9).

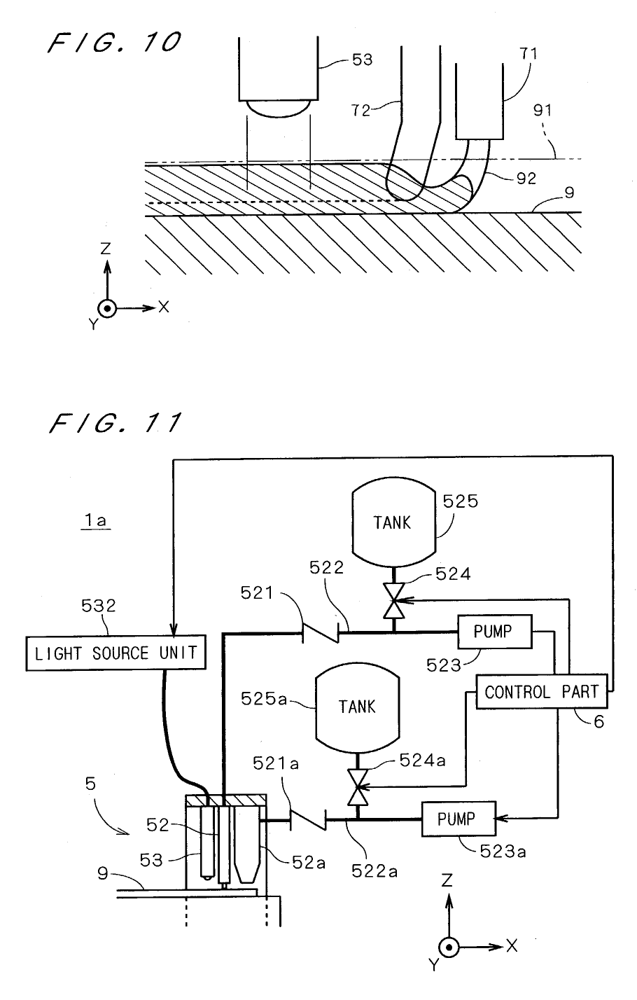

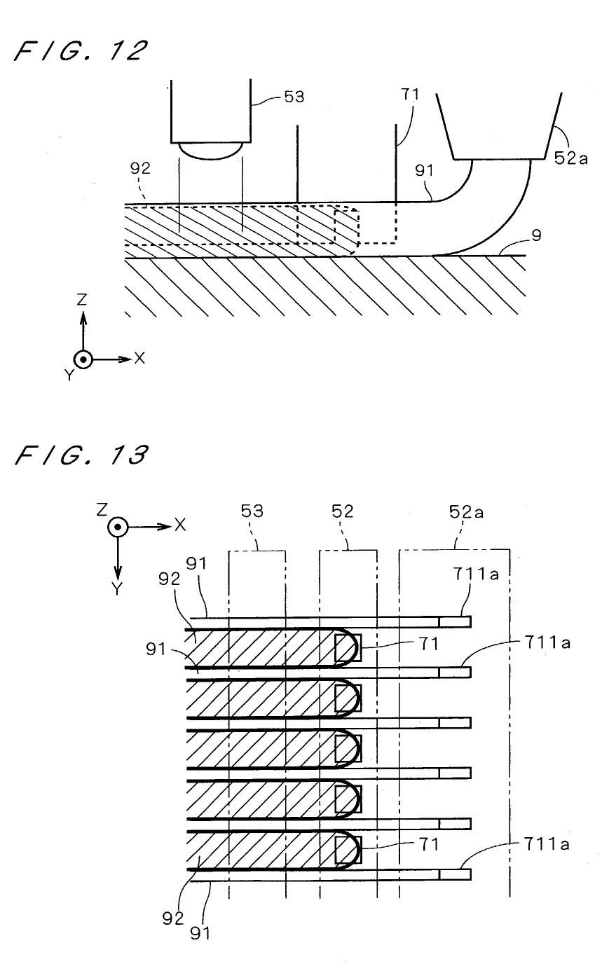

FIG. 9 is a view showing shaping members 72 as viewed from the (−X) side towards the (+X) side, and FIG. 10 is a view showing the shaping member 72 as viewed from the (+Y) side towards the (−Y) side.

The phosphor paste 92 discharged from the nozzle 71 drops to the valley between the barrier ribs 91 and then is sequentially spread in the valley by the shaping member 72 traveling together with the material discharge part 52 relatively to the substrate 9 as shown in FIGS. 9 and 10. As a result, the phosphor paste 92 is applied to the bottom surface and side surfaces of the valley to have a proper thickness. Further, the irradiation part 5 traveling together with the material discharge part 52 relatively to the substrate 9 emits ultraviolet rays to the shaped phosphor paste 92, to thereby sequentially hardening the phosphor paste 92. The discharge from the nozzle 71 is so controlled as to avoid overflow of the phosphor paste 92 out of the valley between the barrier ribs 91 in shaping.

Thus, the shaping of the phosphor paste 92 can be also performed by the shaping members 72 additionally provided, and in this case, it is not necessary to use nozzles 71 of special shape.

<3. The Third Preferred Embodiment>

FIG. 11 is a view showing the head part 5 of a pattern forming apparatus 1a and its peripheral constitution in accordance with the third preferred embodiment. The pattern forming apparatus 1a is an apparatus for performing formation of barrier ribs on the substrate 9 which has no barrier rib and application of phosphor paste at the same time. Other constituents of the pattern forming apparatus 1a are the same as those of the material applying apparatus 1 in the first preferred embodiment and represented by the same reference signs in the following discussion.

The head part 5 of the pattern forming apparatus 1a has a basic constitution of the head part 5 in the first preferred embodiment and is additionally provided with another material discharge part 52a for discharging a rib material. A supply pipe 522a having a check valve 521a is attached to the material discharge part 52a for discharging the rib material, like the material discharge part 52 for discharging the phosphor paste 92, and the supply pipe 522a is branched off into two pipes, one of which is connected to a pump 523a and the other is connected to a tank 525a for pooling the rib material via a control valve 524a. Discharge of the rib material form the material discharge part 52a is performed, like the material discharge part 52, through suction and ejection of the pump 523a and open and close operation of the control valve 524a by a control of the control part 6.

FIG. 12 is a view showing discharge from the head part 5 as viewed from the (+Y) side towards the (−Y) side, and FIG. 13 is a plan view thereof. In these figures, the phosphor paste 92 discharged from the nozzle 71 of the material discharge part 52 is hatched.

The material discharge part 52a has a plurality of discharge ports 711a arranged in the Y direction as shown in FIG. 13. The discharge ports 711a are positioned on both sides of the nozzle 71 for discharging the phosphor paste 92 (specifically, off from the nozzle 71 by half pitch) with respect to the Y direction. Since the material discharge part 52a is positioned on the front side with respect to the material discharge part 52 in the traveling direction relative to the substrate 9 and travels relatively to the substrate 9 together with the material discharge part 52, the rib material from the discharge ports 711a of the material discharge part 52a is discharged on the substrate 9 before application of the phosphor paste 92, to form the barrier ribs 91. Then, on the rear side of the material discharge part 52a, like in the first preferred embodiment, each nozzle 71 discharges the phosphor paste 92 and the phosphor paste 92 is shaped at the tip of the nozzle 71.

Further, on the rear side of the material discharge part 52, the irradiation part 53 emits ultraviolet rays as shown in FIGS. 12 and 13. The rib material and the phosphor paste 92 each contain a resin which is to be hardened by ultraviolet rays, and the barrier ribs 91 and the phosphor paste 92 are sequentially hardened. This increases the ratio (H/W) of height (H) of the barrier rib 91 to length (W) of a portion thereof in contact with the substrate 9 and makes the shape of the barrier rib 91 and the phosphor paste 92 stable. When the viscosity of the rib material or the phosphor paste 92 is sufficient high, a material having high viscosity do not have to contain an ultraviolet hardening-type resin.

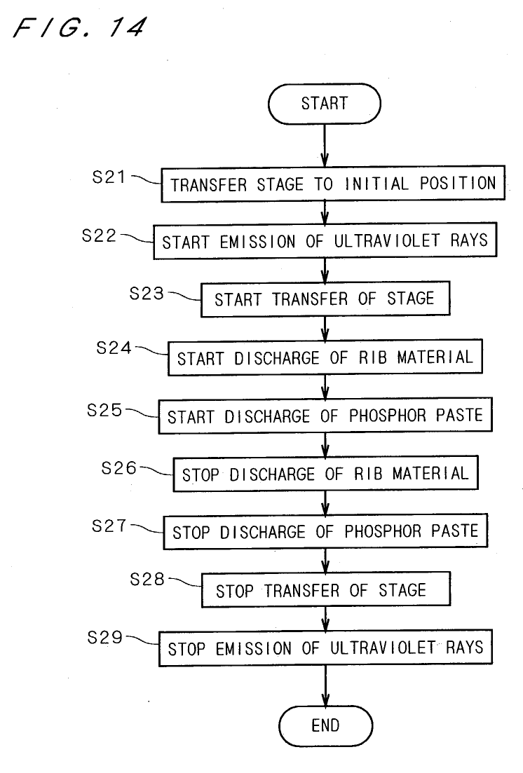

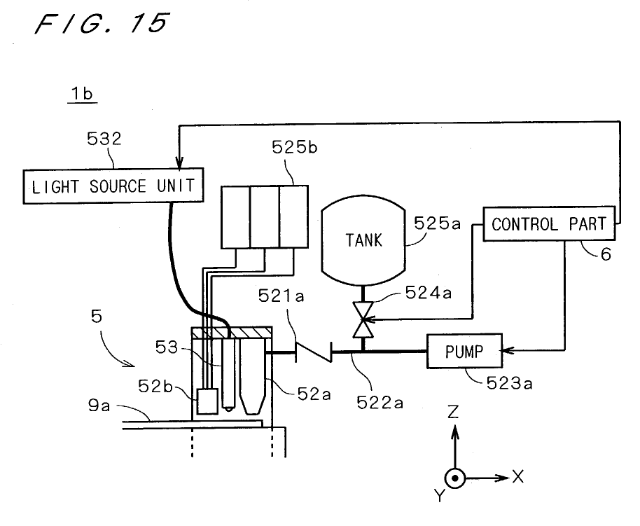

FIG. 14 is a flowchart showing an operation of the pattern forming apparatus 1a. The operation of the pattern forming apparatus 1a is basically the same as that of the material applying apparatus 1 in the first preferred embodiment and an operation of the material discharge part 52a is additionally performed.

First, the stage 3 is transferred to the initial position (see the stage 3 indicated by the phantom line of FIG. 1) (Step S21). Next, the irradiation part 53 starts emission of ultraviolet rays (Step S22), and the stage transfer mechanism 2 starts transfer of the stage 3 in the (−X) direction (Step S23). The head part 5 thereby travels in a direction along the main surface of the substrate 9.

When the material discharge part 52a reaches the discharge start position near the end of the substrate 9 (near the left end of the substrate 9 in FIG. 1), the material discharge part 52a starts discharge of the rib material (Step S24), and further when the material discharge part 52 reaches the discharge start position (or after a certain period from the time when it reaches the position), the material discharge part 52 starts discharge of the phosphor paste towards an area between the barrier ribs (Step S25).

Then, when the material discharge part 52a reaches the discharge stop position near the other end (near the right end of the substrate 9 in FIG. 1), the material discharge part 52a stops the discharge of the rib material (Step S26), and when the material discharge part 52 reaches the discharge stop position (or before the discharge stop position), the material discharge part 52 stops the discharge of the phosphor paste (Step S27). After that, the transfer of the stage 3 and the emission of the ultraviolet rays are also stopped (Steps S28 and S29).

Thus, the pattern forming apparatus 1a can perform formation of the barrier ribs and application of the phosphor paste in parallel through one transfer of the head part 5 (relative to the substrate 9), to thereby reduce the time required for patterning. As a result, it is possible to reduce the cost and time for manufacturing a panel used in a plasma display. Moreover, emission of the ultraviolet rays prevents deformation of the barrier ribs and the phosphor paste. The barrier ribs and the phosphor paste on the substrate 9 are burned in the later process, to achieve burnout of organic substances at the same time.

<4. The Fourth Preferred Embodiment>

FIG. 15 is a view showing part of a pattern forming apparatus 1b for applying color filter materials while forming the barrier ribs, and the part corresponds to FIG. 11 in the third preferred embodiment. Other constituents are the same as those in the first preferred embodiment.

The head part 5 in the pattern forming apparatus 1b has basically the same constitution as in the third preferred embodiment, and the material discharge part 52 for discharging the phosphor paste is replaced by a material discharge part 52b for discharging the color filter materials and the irradiation part 53 is disposed between the material discharge part 52a for discharging the rib material and the material discharge part 52b. The two material discharge parts 52a and 52b and the irradiation part 53 travel as a unit, like in the third preferred embodiment.

The material discharge part 52b has a structure for momentarily discharging (jetting) the color filter materials by heating elements, piezo elements or the like, to individually discharge three color filter materials (for e.g., three primary colors of R (red), G (green) and B (blue)). The color filter materials are supplied by colors from a tank 525b which is additionally provided.

An operation of the pattern forming apparatus 1b is basically the same as in the third preferred embodiment and discharge of the color filter materials is additionally performed. Specifically, as shown in FIG. 14, first, the transfer of the stage 3 and the emission of the ultraviolet rays from the irradiation part 53 are started (Step S21 to S23), and the discharge of the rib material from the material discharge part 52a is started (Step S24). Through these operations, a plurality of barrier ribs are sequentially formed on a substrate 9a for a color filter.

On the other hand, when the barrier ribs reaches below the material discharge part 52b, the material discharge part 52b starts discharge of the color filter materials between the barrier ribs (Step S25). As a result, formation of the barrier ribs and application of the color filter materials are performed in parallel. Then, when the head part 5 reaches a rear end of the substrate 9a, the discharge of the rib material and that of the color filter materials are stopped (Step S26 and S27) and the transfer of the stage 3 and the emission of the ultraviolet rays are also stopped (Steps S28 and S29). Thus, the pattern forming apparatus 1b of FIG. 15 can perform formation of the barrier ribs of the color filter and application of the color filter materials at the same time, and therefore reduction in manufacturing time and cost is achieved.

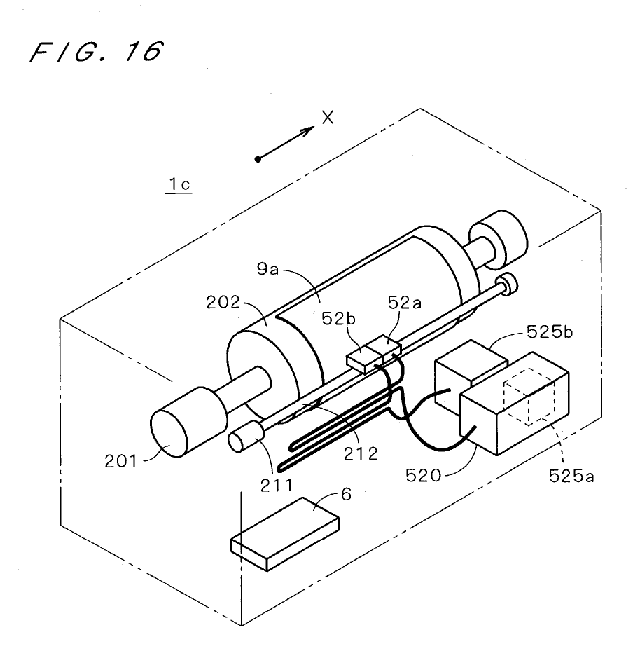

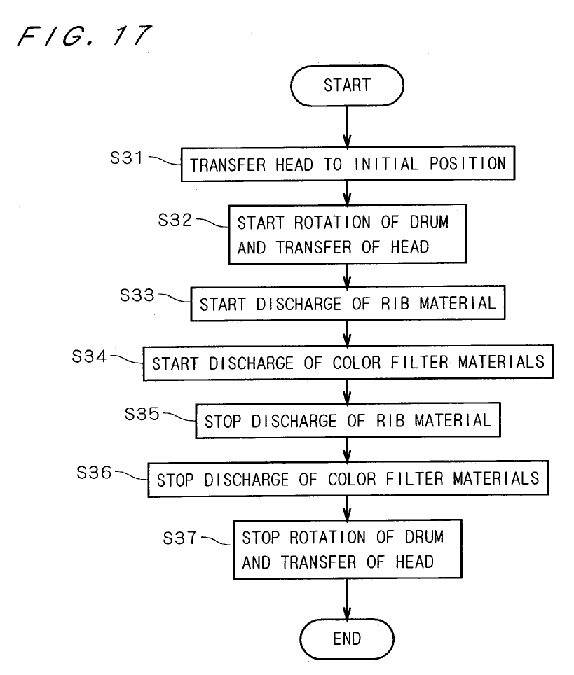

FIG. 16 is a perspective view showing another exemplary pattern forming apparatus 1c for performing formation of the barrier ribs of the color filter and application of the color filter materials in parallel. The pattern forming apparatus 1c has a cylindrical drum 202 rotated about an axis extending in the X direction of FIG. 16 by a motor 201 and the substrate 9a for a color filter is attached on a side surface of the drum 202. The material discharge part 52 for discharging the rib material and the material discharge part 52b for discharging the color filter materials are disposed near the side surface of the drum 202. The material discharge part 52a has a plurality of discharge ports arranged in the X direction. The material discharge part 52b has a structure for momentarily discharging (jetting) the color filter materials by the heating elements, the piezo elements or the like, and discharges the color filter materials from a plurality of discharge ports arranged in the X direction.

The material discharge parts 52a and 52b can be transferred in the X direction by a motor 211 and a feed screw 212. Further, the material discharge parts 52a and 52b are fixed to each other and travel as a unit. The material discharge part 52a is connected to a feeding mechanism 520 of the rib material and fed with the rib material from a tank 525a in the feeding mechanism 520. On the other hand, the material discharge part 52b is connected to a tank 525b for individually pooling the color filter materials for a plurality of colors.

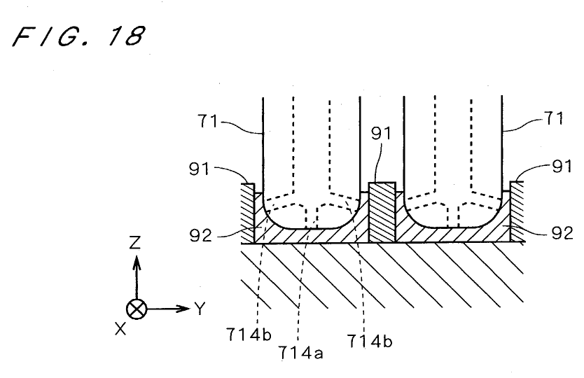

FIG. 17 is a flowchart showing an operation of the pattern forming apparatus 1c. The operation of FIG. 17 is controlled by the control part 6 in the pattern forming apparatus 1c. First, the material discharge parts 52a and 52b (hereinafter, generally referred to as “head”) travel to the initial position (on the −X side) (Step S31), and rotation of the drum 202 is started by the motor 201 and transfer of the head (intermittent transfer at every rotation of the drum 202) towards the (+X) direction is started by the motor 211 (Step S32).

When the material discharge part 52a reaches an end of the substrate 9a on the (−X) side, the material discharge part 52a starts discharge of the rib material (Step S33) to form a plurality of barrier ribs on the substrate 9a at the same time. Then, when the material discharge part 52b reaches the end of the substrate 9a on the (−X) side, the material discharge part 52b starts discharge of the color filter materials (Step S34) to apply the color filter materials between a plurality of barrier ribs on the substrate 9a. Through repeating the intermittent transfer of the head, formation of the barrier ribs on the substrate 9a and application of the color filter materials are performed in parallel.

When the material discharge part 52a reaches an end of the substrate 9a on the (+X) side, the material discharge part 52a stops the discharge of the rib material (Step S35), and when the material discharge part 52b reaches the end of the substrate 9a on the (+X) side, the material discharge part 52b stops the discharge of the color filter materials (Step S36). After that, the rotation of the drum 202 and the transfer of the head are stopped (Step S37), to finish the processing of the substrate 9a.

Thus, the technique to perform formation of the barrier ribs and application of the color filter materials in parallel can be applied to a mechanism for rotating the drum supporting the substrate 9a, and therefore, reduction in time and cost for manufacturing the color filter is achieved.

<5. Variations>

Though the preferred embodiments of the present invention have been discussed above, the present invention is not limited to the above-discussed preferred embodiments but allows various variations.

The material applying apparatus and the pattern forming apparatus can be used not only to manufacture the panel for the plasma display and the color filter but also to manufacture parts for other flat panel displays (FPD) (to form patterns on a substrate using a pattern material such as a rib-space material and a rib material), like a technique to apply a luminescent material on a panel of the organic EL display. Further, the substrate is not limited to a glass substrate.

Even in manufacturing the color filter, a method of discharging the color filter materials from a nozzle-like discharge part can be used like in the first to third preferred embodiments. Further, by using a color filter material containing a component which is to be hardened by light or the like, a proper shaping of the color filter material is achieved. Operations in the case of manufacturing the color filter in the first to third preferred embodiments are basically the same as the operations shown in FIG. 6 or 14, and the color filter materials are used instead of the phosphor paste.

Though the head part 5 travels relatively to the substrate 9 through the transfer of the stage 3 in the apparatus of the first to third preferred embodiments and FIG. 15, there may be a case where the stage 3 is fixed and the head part 5 travels. Further, the width of the material discharge part 52 (material discharge parts 52a and 52b) may be less than the length crossing the substrate 9, and in this case, the head part 5 travels in a direction (the Y direction of FIG. 1) orthogonal to the traveling direction of the head part 5 relative to the substrate 9 and the discharge is repeated for other areas.

The traveling direction of the head part 5 relative to the substrate 9 is not limited to one way, and the head part 5 may perform a to-and-fro motion. In this case, for example, the irradiation parts 53 and the shaping members 72 are provided on both sides of the material discharge part 52 and emission of ultraviolet rays may be performed from only the irradiation part 53 on the rear in the traveling direction relative to the substrate 9 in the first and second preferred embodiments. Alternatively, the head part 5 may be rotate in accordance with the traveling direction relative to the substrate 9 in the apparatus of the first to third preferred embodiments and FIG. 16.

Though the phosphor paste (including the barrier ribs in the third preferred embodiment) on the substrate 9 immediately after discharge is hardened by ultraviolet rays in the first to third preferred embodiments, the hardening of the phosphor paste is not limitedly performed by the ultraviolet rays or other type lights, it may be performed by applying e.g., heat, oxygen gas, humid gas or the like to the phosphor paste and the like. Hardening of the color filter materials in the fourth preferred embodiment may be also performed not only by the ultraviolet rays and other type lights but also by heat, oxygen gas, humid gas or the like.

The shape of the nozzle 71 in the first to third preferred embodiments may be changed as appropriate. Since the phosphor paste (or color filter material) is shaped in accordance with the shape on the rear portion of the nozzle 71 with respect to the traveling direction, a proper application for an area between the barrier ribs can be achieved by discharge from a portion of the nozzle 71 other than the rear with respect to the traveling direction on the substrate 9. Further, application of the phosphor paste can be surely performed between the barrier ribs by discharging the phosphor paste from portions of the nozzle 71 including both sides with respect to the traveling direction.

FIG. 18 is a view showing another example of the nozzle 71. The nozzle 71 is provided with a discharge port 714a at the bottom thereof and discharge ports 714b on side surfaces facing the barrier ribs 91, to thereby surely perform application onto the bottom surface and side surfaces between the barrier ribs. Naturally, another discharge port may be provided on the front of the nozzle 71 shown in FIG. 18.

The shaping member 72 is not necessarily of paddle-like shape as shown in FIG. 10, and may be a stick-like member with a tip having a shape in accordance with the shaping of the phosphor paste.

Though discussions have been made on the premise that the barrier ribs are formed on the substrate by discharging the rib material in the third and fourth preferred embodiments, a method of forming the barrier ribs is not limited to the discharge. For example, the barrier ribs may be sequentially formed by a method of removing the rib material which is uniformly applied on the substrate.

Though the two material discharge parts 52a and 52b, which are fixed to each other, are easily transferred in synchronization in the apparatus of FIG. 16, these material discharge parts 52a and 52b may travel individually.

While the invention has been shown and described in detail, the foregoing description is in all aspects illustrative and not restrictive. It is therefore understood that numerous modifications and variations can be devised without departing from the scope of the invention.

What is claimed is:

1. A method of applying a predetermined material between barrier ribs formed on a substrate for a flat panel display, comprising:
a discharge start step of transferring a material discharge part relatively to said substrate in a direction along said barrier ribs and starting discharge of said predetermined material from said material discharge part towards an area between said barrier ribs;
a discharge stop step of stopping said discharge of said predetermined material from said material discharge part; and
a hardening step of sequentially hardening said predetermined material discharged on said substrate from said discharge start step to said discharge stop step.

2. A method of applying a predetermined material between barrier ribs formed on a substrate for a flat panel display, comprising:
a discharge start step of transferring a nozzle inserted between said barrier ribs relatively to said substrate in a direction along said barrier ribs and starting discharge of said predetermined material from said nozzle; and
a discharge stop step of stopping said discharge of said predetermined material from said nozzle,
wherein said nozzle discharges said predetermined material from a portion thereof other than the rear with respect to a traveling direction on said substrate.

3. The method according to claim 2, wherein
said nozzle discharges said predetermined material from a portion thereof including the side with respect to said traveling direction.

4. The method according to claim 2, further comprising:
a hardening step of sequentially hardening said predetermined material discharged on said substrate from said discharge start step to said discharge stop step.

5. A method of applying a predetermined material between barrier ribs formed on a substrate for a flat panel display, comprising:
a discharge start step of transferring a material discharge part relatively to said substrate in a direction along said barrier ribs and starting discharge of said predetermined material from said material discharge part towards an area between said barrier ribs;
a discharge stop step of stopping said discharge of said predetermined material from said material discharge part; and
a shaping step of sequentially shaping said predetermined material discharged on said substrate from said discharge start step to said discharge stop step.

6. The method according to claim 5, further comprising:
a hardening step of sequentially hardening said predetermined material discharged on said substrate from said discharge start step to said discharge stop step.

7. A method of forming a pattern on a substrate for a flat panel display, comprising:
a barrier-rib forming step of forming barrier ribs on a main surface of said substrate; and
a material discharge step of discharging a predetermined material towards an area between said barrier ribs on said substrate in parallel with said barrier-rib forming step.

8. The method according to claim 7, wherein
said barrier-rib forming step comprises
a first discharge start step of transferring a first material discharge part having a plurality of discharge ports relatively to said substrate in a direction along said main surface of said substrate and starting discharge of a rib material from said first material discharge part; and
a first discharge stop step of stopping said discharge from said first material discharge part, and
said material discharge step comprises
a second discharge start step of transferring a second material discharge part together with said first material discharge part and starting discharge of said predetermined material from said second material discharge part towards said area between said barrier ribs on said substrate; and
a second discharge stop step of stopping said discharge from said second material discharge part.

9. The method according to claim 8, further comprising the step of:
sequentially hardening said rib material discharged on said substrate from said first discharge start step to said first discharge stop step.

10. The method according to claim 8, further comprising the step of:
sequentially hardening said predetermined material discharged on said substrate from said second discharge start step to said second discharge stop step.

11. An apparatus for applying a predetermined material between barrier ribs formed on a substrate for a flat panel display, comprising:
a material discharge part for discharging a predetermined material towards an area between said barrier ribs;
a transfer mechanism for transferring said material discharge part relatively to said substrate in a direction along said barrier ribs; and
a hardening part traveling together with said material discharge part, for hardening said predetermined material discharged on said substrate.

12. An apparatus for applying a predetermined material between barrier ribs formed on a substrate for a flat panel display, comprising:
a material discharge part for discharging a predetermined material from a nozzle inserted between barrier ribs; and
a transfer mechanism for transferring said material discharge part relatively to said substrate in a direction along said barrier ribs,
wherein said nozzle discharges said predetermined material from a portion thereof other than the rear with respect to a traveling direction on said substrate.

13. The apparatus according to claim 12, wherein
said nozzle discharges said predetermined material from a portion thereof including the side with respect to said traveling direction.

14. The apparatus according to claim 12, further comprising:
a hardening part traveling together with said material discharge part, for hardening said predetermined material discharged on said substrate.

15. An apparatus for applying a predetermined material between barrier ribs formed on a substrate for a flat panel display, comprising:
a material discharge part for discharging a predetermined material towards an area between said barrier ribs;
a transfer mechanism for transferring said material discharge part relatively to said substrate in a direction along said barrier ribs; and
a shaping member inserted in said predetermined material discharged between said barrier ribs, traveling together with said material discharge part.

16. The apparatus according to claim 15, further comprising:
a hardening part traveling together with said material discharge part, for hardening said predetermined material discharged on said substrate.

17. An apparatus for forming a pattern on a substrate for a flat panel display, comprising:
a barrier-rib forming part for forming barrier ribs on a main surface of said substrate;
a transfer mechanism for transferring said barrier-rib forming part relatively to said substrate in a direction along said main surface of said substrate; and
a material discharge part traveling together with said barrier-rib forming part, for discharging a predetermined material towards an area between said barrier ribs formed by said barrier-rib forming part.

18. The apparatus according to claim 17, wherein
said barrier-rib forming part discharges a rib material towards said substrate from a plurality of discharge ports.

19. The apparatus according to claim 17, further comprising:
a hardening part traveling together with said barrier-rib forming part, for hardening said rib material discharged on said substrate.

20. The apparatus according to claim 17, further comprising:
a hardening part traveling together with said barrier-rib forming part, for hardening said predetermined material discharged on said substrate.

21. The apparatus according to claim 17, wherein
said barrier-rib forming part and said material discharge part are fixed to each other.

22. A panel for a flat panel display, comprising:
a substrate; and
a plurality of barrier ribs formed on said substrate; and
a predetermined material sequentially hardened when discharged towards an area between said plurality of barrier ribs from a discharge port.

23. A panel for a flat panel display, comprising:
a substrate; and
a plurality of barrier ribs formed on said substrate; and
a predetermined material shaped by a shaping member when applied between said plurality of barrier ribs.

24. A panel for a flat panel display, comprising:
a substrate; and
a plurality of barrier ribs formed of a rib material discharged from a plurality of discharge ports on said substrate; and
a predetermined material applied between said barrier ribs in parallel with forming said plurality of barrier ribs.
